(19) United States
(12) Patent Application Publication
(10) Pub. No.: US 2025/0202785 A1
(43) Pub. Date: Jun. 19, 2025

(54) METHOD FOR CONVERTING AND STORING TIME SERIES DATA OF IOT EVENTS

(71) Applicant: Korea Electronics Technology Institute, Seongnam-si (KR)

(72) Inventor: Tai Gil KWON, Seongnam-si (KR)

(21) Appl. No.: 18/977,046

(22) Filed: Dec. 11, 2024

(30) Foreign Application Priority Data
Dec. 14, 2023 (KR) 10-2023-0181946

(51) Int. Cl. H04L 43/067; H04L 43/028; H04L 43/106

(52) U.S. Cl. CPC H04L 43/067; H04L 43/028; H04L 43/106

(57) ABSTRACT

Proposed is a method for converting and storing time series data of Internet of Things (IoT) events. The method may include converting sensing data received from an IoT device into an event according to a preset first data format. The method may also include converting the event into a tuple according to a preset second data format. The method may further include storing the time series data in a database table in a multidimensional time series data format based on the tuple.

### CROSS-REFERENCE TO RELATED APPLICATION

This application claims priority from and the benefit of Korean Patent Application No. 10-2023-0181946, filed on Dec. 14, 2023, which is hereby incorporated by reference for all purposes as if set forth herein.

### BACKGROUND

### Technical Field

The present disclosure relates to a method for converting and storing time series data of Internet of Things (IoT) events.

### Description of Related Technology

Generally, an IoT platform receives sensing data of IoT devices using various network protocols, generates event information based on even generation time timestamp, and then sequentially transmits the event information to an application.

### SUMMARY

One aspect is a method in which sensing data acquired from IoT devices using various protocols is converted into event information by an IoT platform, and the converted event information is reconverted into multidimensional time series data information according to specific conditions and is stored in a database in a form that makes it easy to analyze data in an application.

Another aspect is a method for converting and storing time series data of IoT events according to the present disclosure includes: (a) converting sensing data received from an IoT device into an event according to a preset first data format; (b) converting the event into a tuple according to a preset second data format; and (c) storing the time series data in a database table in a multidimensional time series data format based on the tuple.

In (a), the sensing data is converted into the event according to the first data format including sensing information content constituted by an event identifier indicating a universally unique identifier being an identifier for distinguishing respective events, a timestamp indicating an event generation time, a device name indicating a device having transmitted sensing information, a resource name, a type of value, and a value.

In (b), the event is converted into the tuple according to the second data format including time series data including a timestamp and a value, a timestamp indicating an event generation time and having a preset format, and a value having an arrangement structure including an integer or decimal value.

In (c), sensing information satisfying preset conditions is filtered and processed according to a filtering condition data format including a base device name indicating a device that is a base for filtering, a time limit indicating a processing range of an event to be filtered within a time limit after an event including the base device is first received, a time unit indicating a unit of time used for the time limit, a device name, and a filter list constituted by a resource list and indicating a list of sensing information to be filtered.

Another aspect is a system for converting and storing time series data of IoT events that includes: an input interface device that receives sensing data received from an IoT device; a memory that stores a program for converting the sensing data into time series data for an IoT event and storing the time series data; and a processor that executes the program, wherein the processor converts the sensing data into an event according to a preset first data format, converts the event into a tuple according to a preset second data format, and stores the time series data in a database table in a multidimensional time series data format based on the tuple.

The processor converts the sensing data into the event according to the first data format including sensing information content constituted by an event identifier indicating a universally unique identifier being an identifier for distinguishing respective events, a timestamp indicating an event generation time, a device name indicating a device having transmitted sensing information, a resource name, a type of value, and a value.

The processor converts the event into the tuple according to the second data format including time series data including a timestamp and a value, a timestamp indicating an event generation time and having a preset format, and a value having an arrangement structure including an integer or decimal value.

The processor filters and processes sensing information satisfying preset conditions according to a filtering condition data format including a base device name indicating a device that is a base for filtering, a time limit indicating a processing range of an event to be filtered within a time limit after an event including the base device is first received, a time unit indicating a unit of time used for the time limit, a device name, and a filter list constituted by a resource list and indicating a list of sensing information to be filtered.

According to the present disclosure, an application can select data of interest from different types of event information generated from various devices, acquire multidimensional time series data that is easy for data analysis, and support focusing only on data analysis, thereby reducing research and development costs and time.

The effects of the present disclosure are not limited to the above-mentioned effects, and the other effects which are not mentioned herein will be clearly understood from the following descriptions by those skilled in the art.

### BRIEF DESCRIPTION OF THE DRAWINGS

FIG. 1 illustrates a time series data storage method for events in the related art.

FIG. 2 illustrates a time series data conversion and storage method according to embodiments of the present disclosure.

FIG. 3 illustrates an event JSON data format according to embodiments of the present disclosure.

FIG. 4 illustrates an event according to a JSON data format according to embodiments of the present disclosure.

FIG. 5 illustrates a tuple JSON data format according to embodiments of the present disclosure.

FIG. 6 illustrates a tuple according to a JSON data format according to embodiments of the present disclosure.

FIG. 7 illustrates sensing information filtering according to specific conditions according to embodiments of the present disclosure.

FIG. 8 illustrates a filtering condition JSON data format according to embodiments of the present disclosure.

FIG. 9 illustrates a filtering condition according to a JSON data format according to embodiments of the present disclosure.

FIG. 10 illustrates a process in which a data conversion module according to embodiments of the present disclosure converts an event received from an IoT platform into time series data.

FIG. 11 is a block diagram illustrating a computer system for implementing a method according to embodiments of the present disclosure.

### DETAILED DESCRIPTION

Since an application, that receives event information from an IoT platform, sequentially stores such event information in a database, the event information is stored in a data format not suitable for data analysis using machine learning, deep learning, statistics, and the like, and there is a problem in that big data analysis is difficult.

The above-described object, other objects, advantages, and characteristics of the present disclosure and a method for achieving them will become apparent from embodiments to be described in detail below together with the accompanying drawings.

However, the present disclosure is not limited to the embodiments to be disclosed below, but may be implemented in various forms different from each other, and the following embodiments are merely provided to easily inform those skilled in the art in the art to which the present disclosure pertains of the object, configuration, and effect of the present disclosure. Therefore, the scope of the present disclosure is defined by the claims.

Terms used in the present specification are used for describing embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements, steps, operations, and/or elements in addition to a mentioned element, step, operation, and/or element.

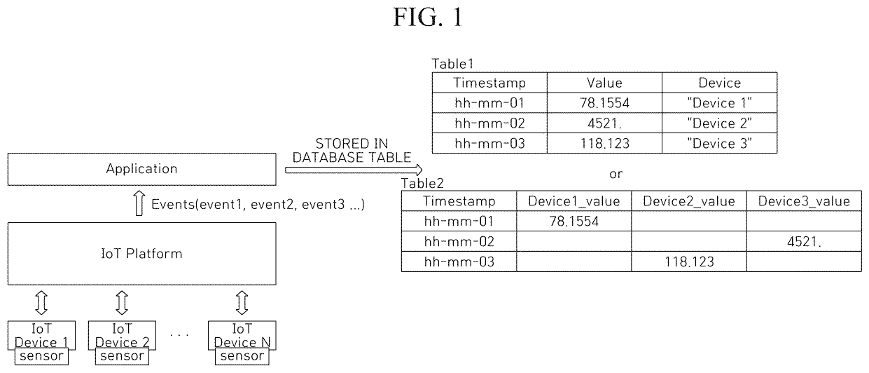

FIG. 1 illustrates a time series data storage method for events in the related art, and illustrates a method in which an application stores, as time series data, events received from an IoT platform.

The IoT platform converts data into event information finally presented in Table 1 below through integrated linkage with IoT devices using various network protocols and transmits the event information to an application.

TABLE 1

| Name | Description |
|---|---|
| timestamp | Event generation time |
| deviceName | Name of device having transmitted sensing |
| | data |
| sensorName | Sensor name |
| value | Sensing value |

The application having received such events may store time series data in the form of Table 1 or Table 2 illustrated in FIG. 1, based on sequentially received events.

However, since the time series data in the form of Table 1 and Table 2 is stored in a data format not suitable for data analysis using machine learning, deep learning, statistics, and the like, there is a problem in that big data analysis is difficult and there is a need for conversion into multidimensional time series data information for storage.

The application stores sensing data of the IoT devices using various network protocols in a database in the form of time series data through events from the IoT platform, and the present disclosure relates to a software field that converts events received from the IoT platform into time series data and stores the time series data.

The present disclosure has been made to solve the above-mentioned problem, and according to embodiments of the present disclosure, various types of event information is reconverted into multidimensional time series data information according to specific conditions and is then transmitted to an application. Since the application sequentially stores the multidimensional time series data information in a database, there is a technical feature that data analysis is facilitated.

A time series data conversion and storage architecture for an event according to embodiments of the present disclosure and a time series data conversion processing method for an event are described below.

### 1. Time Series Data Conversion and Storage Architecture for Event

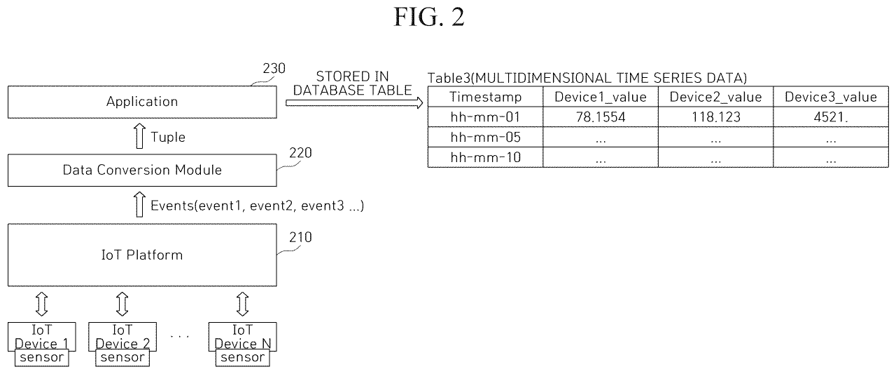

FIG. 2 illustrates a time series data conversion and storage method according to embodiments of the present disclosure, and illustrates a method for converting events received from an IoT platform 210 into time series data and then storing the time series data in an application.

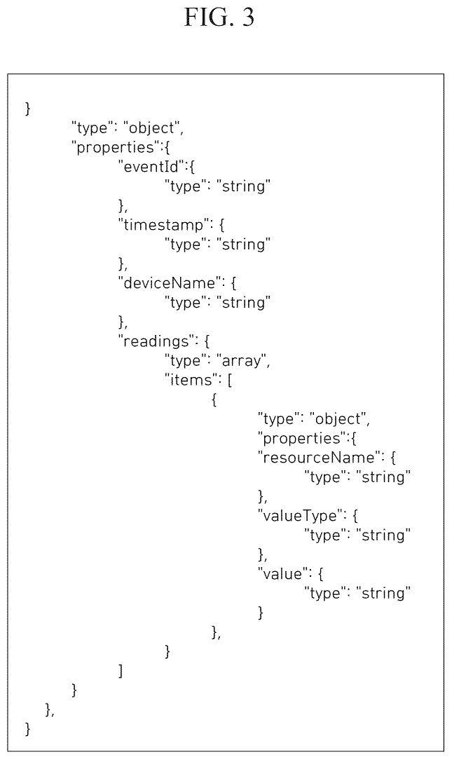

Sensing data transmitted from IoT devices is transmitted to the IoT platform 210, and the IoT platform 210 converts the sensing data into events according to a JSON data format in FIG. 3 to be described below and transmits the events to a data conversion module 220.

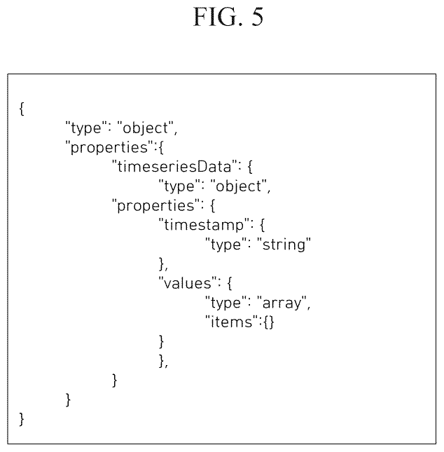

The data conversion module 220 reconverts the events into tuples according to a JSON data format in FIG. 5 to be described below and transmits the tuples to an application 230.

The application 230 stores the tuples in a database table in a multidimensional time series data format.

FIG. 3 illustrates the event JSON data format according to embodiments of the present disclosure.

The meaning of the event JSON data format is as shown in Table 2 below.

TABLE 2

| Name | Type | Description |
|---|---|---|
| eventid | Character string | Event identifier (128-bit UUID) |
| timestamp | Integer | Event generation time (nanosecond) |
| deviceName | Character string | Name of device having transmitted |
| | | sensing information |
| readings | Arrangement | Content of received sensing |
| | | information |
| resourceName | Character string | Resource name |
| | | (sensing data identifier) |
| valueType | Character string | Type of value |
| | | (Int8, Int16, Int32, Int64, |
| | | Uint8, Uint16, Uint32, Uint64, |
| | | Float32, Float64, Bool) |
| value | Character string | value of resource |
| | | (sensing data value) |

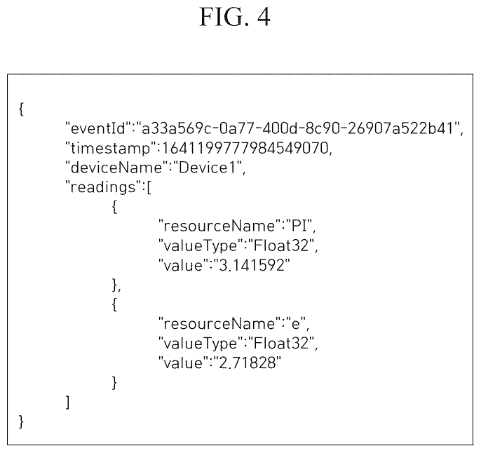

FIG. 4 illustrates an event according to the JSON data format according to embodiments of the present disclosure.

In the JSON data format, the event identifier eventId is an identifier for distinguishing respective events and refers to a 128-bit universally unique identifier, the timestamp timeStamp refers to an event generation time (nanosecond), the device name deviceName refers to a device having transmitted sensing information, and the content (readings) of the received sensing information includes sensing information constituted by a resource name resourceName, a value type valueType, and a value.

FIG. 5 illustrates the tuple JSON data format according to embodiments of the present disclosure.

The meaning of the tuple JSON data format is as shown in Table 3 below.

TABLE 3

| Name | Type | Description |
|---|---|---|
| timeseriesData | Object | |
| timeStamp | Character string | Event generation time (year-month- |
| | | day and hour-minute-second) |
| values | Arrangement | multidimensional time series data |

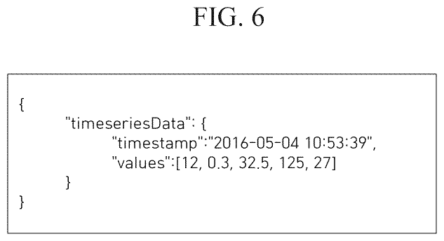

FIG. 6 illustrates a tuple according to the JSON data format according to embodiments of the present disclosure.

In the JSON data format, the timeseriesData includes timestamp and values, the timestamp is an event generation time and has the format of (year-month-day and hour-minute-second), and the values includes an array structure that can include various integer or decimal values.

### 2. Time Series Data Conversion Processing Method for Events

Based on each IoT device linked to the IoT platform, an event following the JSON data format of FIG. 3 described above is generated, and the readings arrangement inside each event includes at least one sensing information constituted by a resource name resourceName, a value type valueType, and a value.

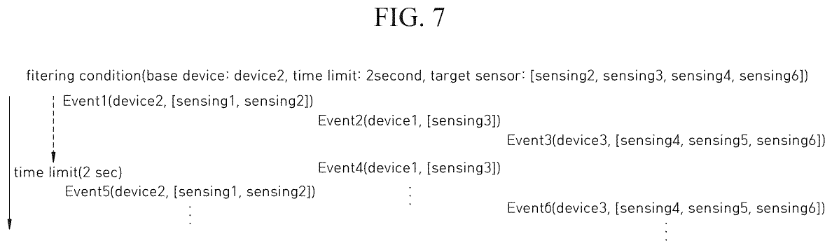

According to embodiments of the present disclosure, in a method for converting an event operating in such a manner into time series data, only sensing information satisfying specific conditions (specific sensing information generated for a specific time based on a specific device) is filtered and processed as illustrated in FIG. 7 (sensing information filtering according to specific conditions according to embodiments of the present disclosure).

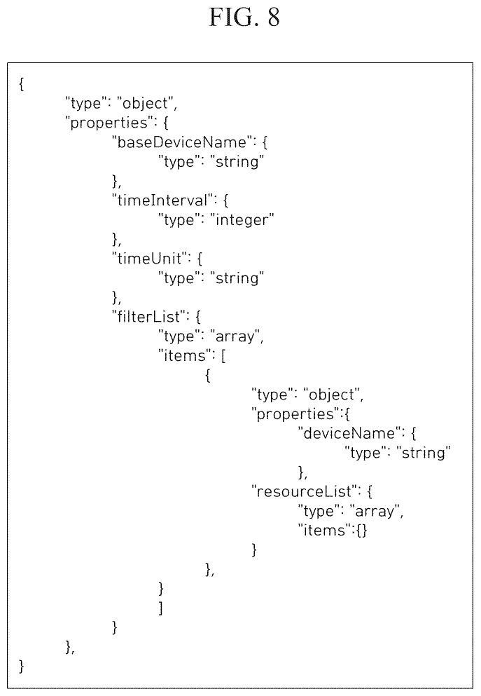

FIG. 8 illustrates a filtering condition JSON data format according to embodiments of the present disclosure.

The meaning of the filtering condition JSON data format is as shown in Table 4 below.

TABLE 4

| Name | Type | Description |
|---|---|---|
| baseDeviceName | Character string | Device name that is |
| | | base for filtering |
| timeLimit | Integer | Time limit |
| timeUnit | Character string | Time unit |
| filterList | Arrangement | List of sensing |
| | | information to be |
| | | filtered |
| deviceName | Character string | Name of device |
| | | having transmitted |
| | | sensing information |
| resourceList | Arrangement | List of sensing data |
| | | identifiers to be |
| | | filtered |

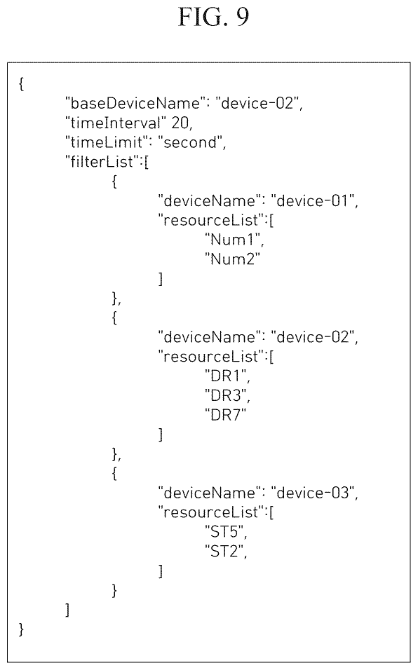

FIG. 9 illustrates a filtering condition according to the JSON data format according to embodiments of the present disclosure.

In the JSON data format, the base device name baseDeviceName refers to a device that is the base for filtering, the time limit timeLimit refers to the processing range of an event to be filtered within the time limit after an event including the base device is first received, the time unit timeUnit refers to the unit of time used for the time limit timeLimit, and the filter list filterList refers to a list of sensing information that is composed of the device name and the resource list and is to be subjected to filtering.

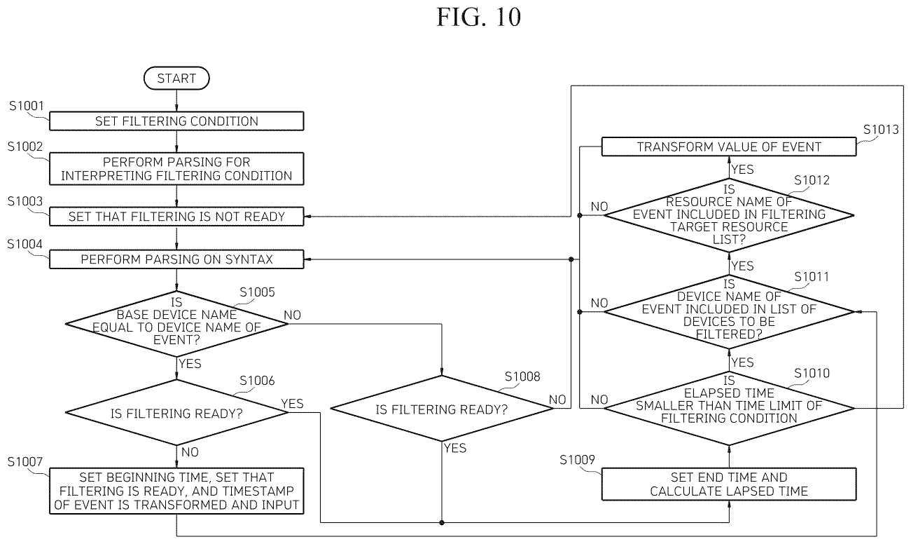

FIG. 10 illustrates a process in which the data conversion module according to embodiments of the present disclosure converts an event received from an IoT platform into time series data.

In step S1001, the data conversion module sets a filtering condition according to the format of FIG. 8 described above.

In step S1002, the data conversion module performs parsing on a syntax so that the set filtering condition may be interpreted.

In step S1003, the data conversion module sets that filtering is not ready yet (filteringReady=false).

In step S1004, the data conversion module performs parsing on the syntax so that a received event having the format of FIG. 3 may be interpreted.

In step S1005, the data conversion module compares whether a base device name filtering.baseDeviceName of the filtering condition is equal to a device name evnet.deviceName of the event. When the names are equal to each other, the data conversion module performs step S1006, and otherwise, the data conversion module performs step S1008.

In step S1006, when filtering is ready (filteringReady is true), the data conversion module performs step S1009, and otherwise, the data conversion module performs step S1007.

In step S1007, the data conversion module sets the beginning time (beginTime=time( )), sets that filtering is ready (filteringReady=true), and converts the timestamp event.timestamp of the event according to the tuple timestamp tuple.timestamp format illustrated in FIG. 5 and inputs the converted timestamp.

In step S1008, the data conversion module checks whether the filtering is ready (filteringReady is true). When the filtering is ready, the data conversion module performs step S1009, and otherwise, the data conversion module performs step S1004.

In step S1009, the data conversion module sets the end time (endTime=time( )) and calculates the elapsed time (elaspTime=endTime−beginTime).

In step S1010, the data conversion module checks whether the elapsed time (elaspTime) is smaller than the time limit of the filtering condition. When the elapsed time is smaller than the time limit of the filtering condition, the data conversion module performs step S1011, and when the elapsed time is larger than the time limit of the filtering condition, the data conversion module performs step S1004.

In step S1011, the data conversion module checks whether the device name event.deviceName of the event is included in the list filtering.filterList[deviceName] of devices to be filtered. When the device name event.deviceName of the event is included in the list filtering.filterList[deviceName] of devices to be filtered, the data conversion module performs step S1012, and otherwise, the data conversion module performs step S1004.

In step S1012, when the resource name event.resourceName of the event is included in the filtering target resource list filtering.filterList[resourceList[ ]], the data conversion module performs step S1013, and otherwise, the data conversion module performs step S1014.

In step S1013, the data conversion module checks which column (index) the resource name of the event corresponds to in the entire filtering resource list, converts the value event.value of the event into a numerical value, and inputs the numerical value to a corresponding column position tuple.values[index] in the tuple values arrangement.

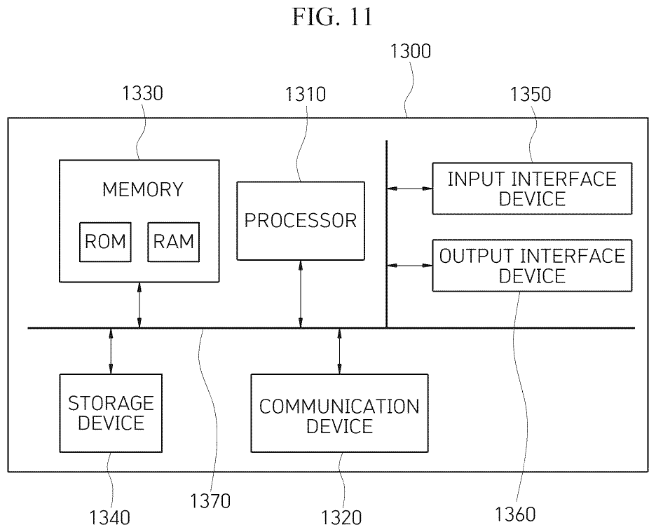

FIG. 11 is a block diagram illustrating a computer system for implementing the method according to embodiments of the present disclosure.

Referring to FIG. 11, a computer system 1300 may include at least one of a processor 1310, a memory 1330, an input interface device 1350, an output interface device 1360, and a storage device 1340 that communicate with one another via a bus 1370. The computer system 1300 may also include a communication device 1320 connected to a network. The processor 1310 may be a central processing unit (CPU), or a semiconductor device that executes instructions stored in the memory 1330 or the storage device 1340. The memory 1330 and the storage device 1340 may include various types of volatile or nonvolatile storage media. For example, the memory may include a read only memory (ROM) and a random access memory (RAM). In the embodiments of the present disclosure, the memory may be located inside or outside the processor, and may be connected to the processor through various means already known. The memory may be various types of volatile or nonvolatile storage media, and for example, may include a read-only memory (ROM) or a random access memory (RAM).

The time series data conversion and storage system for an IoT event according to embodiments of the present disclosure includes the input interface device 1350 that receives sensing data received from an IoT device, the memory 1330 that stores a program for converting the sensing data into time series data for an IoT event and storing the time series data, and the processor 1310 that executes the program. The processor 1310 converts the sensing data into an event according to a preset first data format, converts the event into a tuple according to a preset second data format, and stores the time series data in a database table in a multidimensional time series data format based on the tuple.

The processor 1310 converts the sensing data into the event according to the first data format including sensing information content constituted by an event identifier indicating a universally unique identifier being an identifier for distinguishing respective events, a timestamp indicating an event generation time, a device name indicating a device having transmitted sensing information, a resource name, a type of value, and a value.

The processor 1310 converts the event into the tuple according to the second data format including time series data including a timestamp and a value, a timestamp indicating an event generation time and having a preset format, and a value having an arrangement structure including an integer or decimal value.

The processor 1310 filters and processes sensing information satisfying preset conditions according to a filtering condition data format including a base device name indicating a device that is a base for filtering, a time limit indicating a processing range of an event to be filtered within a time limit after an event including the base device is first received, a time unit indicating a unit of the time used for the time limit, and the filter list filterList refers to a list of sensing information that is composed of the device name and the resource list and is to be subjected to filtering.

Accordingly, the embodiments of the present disclosure can be implemented as a computer-implemented method or as a non-transitory computer-readable medium storing computer-executable instructions. In one embodiment, when executed by a processor, the computer-readable instructions may perform a method according to at least one aspect of the present disclosure.

The communication device 1320 may transmit or receive a wired signal or a wireless signal.

In addition, the method according to the embodiments of the present disclosure may be implemented in the form of program instructions executable through various computer means and recorded on a computer-readable medium.

The computer-readable medium may include program instructions, data files, data structures, and the like singly or in combination. The program instructions recorded on the computer-readable medium may be specially designed and configured for the embodiments of the present disclosure or may be known and available to those skilled in the art of computer software. The computer-readable recording medium may include a hardware device configured to store and execute the program instructions. For example, the computer-readable recording medium may be magnetic media such as a hard disk, a floppy disk, and a magnetic tape, optical media such as a CD-ROM, a DVD, magneto-optical media such as a floptical disk, a ROM, a RAM, a flash memory, and the like. The program instructions may include not only machine language codes such as those generated by a compiler, but also high-level language codes executable by a computer through an interpreter and the like.

Although the embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

What is claimed is:

1. A method for converting and storing time series data of Internet of Things (IoT) events performed by a system for converting and storing the time series data of the IoT events, the method comprising:
converting sensing data received from an IoT device into an event according to a preset first data format;
converting the event into a tuple according to a preset second data format; and
storing the time series data in a database table in a multidimensional time series data format based on the tuple.

2. The method of claim 1, wherein converting the sensing data comprises:
converting the sensing data into the event according to the first data format including sensing information content constituted by an event identifier indicating a universally unique identifier being an identifier for distinguishing respective events, a timestamp indicating an event generation time, a device name indicating a device having transmitted sensing information, a resource name, a type of value, and a value.

3. The method of claim 1, wherein converting the event comprises:
converting the event into the tuple according to the second data format including time series data including a timestamp and a value, a timestamp indicating an event generation time and having a preset format, and a value having an arrangement structure including an integer or decimal value.

4. The method of claim 1, wherein the storing comprises:
filtering and processing sensing information satisfying preset conditions according to a filtering condition data format including a base device name indicating a device that is a base for filtering, a time limit indicating a processing range of an event to be filtered within a time limit after an event including the base device is first received, a time unit indicating a unit of time used for the time limit, and a filter list indicating a list of sensing information that is composed of a device name and a resource list and is to be subjected to filtering.

5. A system for converting and storing time series data of Internet of Things (IoT) events, the system comprising:
an input interface configured to receive sensing data received from an IoT device;
a memory that stores a program configured to convert the sensing data into time series data for an IoT event and store the time series data; and
a processor configured to execute the program to:
convert the sensing data into an event according to a preset first data format,
convert the event into a tuple according to a preset second data format, and
store the time series data in a database table in a multidimensional time series data format based on the tuple.

6. The system of claim 5, wherein the processor is configured to:
convert the sensing data into the event according to the first data format including sensing information content constituted by an event identifier indicating a universally unique identifier being an identifier for distinguishing respective events, a timestamp indicating an event generation time, a device name indicating a device having transmitted sensing information, a resource name, a type of value, and a value.

7. The system of claim 5, wherein the processor is configured to:
convert the event into the tuple according to the second data format including time series data including a timestamp and a value, a timestamp indicating an event generation time and having a preset format, and a value having an arrangement structure including an integer or decimal value.

8. The system of claim 5, wherein the processor is configured to:
filter and process sensing information satisfying preset conditions according to a filtering condition data format including a base device name indicating a device that is a base for filtering, a time limit indicating a processing range of an event to be filtered within a time limit after an event including the base device is first received, a time unit indicating a unit of time used for the time limit, and a filter list indicating a list of sensing information that is composed of a device name and a resource list and is to be subjected to filtering.
